(19) United States
(12) Patent Application Publication
(10) Pub. No.: US 2004/0244448 A1
(43) Pub. Date: Dec. 9, 2004

(54) Urea condensate-organic waste material products

(76) Inventor: David H. Blount, San Diego, CA (US)

Correspondence Address: David H. Blount, 6728 Del Cerro Blvd., San Diego, CA, 92120, US

(21) Appl. No.: 10/859,716

(22) Filed: Jun. 3, 2004

Related U.S. Application Data
(63) Continuation-in-part of application No. 08/723,779, filed on Sep. 30, 1996, now Pat. No. 5,854,309.
(63) Continuation-in-part of application No. 09/693,194, filed on Oct. 23, 2000, now Pat. No. 6,464,903.
(63) Continuation-in-part of application No. 09/973,553, filed on Oct. 9, 2001, now Pat. No. 6,777,469.

(51) Int. Cl. C05F 1/00

(52) U.S. Cl. 71/28

(57) ABSTRACT

Partially hydrolyzed urea condensate-organic waste material, urea condensate-organic waste material are produced by mixing, heating and reacting urea with organic waste materials such as sewer sludge, garbage, cannery waste and composed organic material and urea. When a wet organic waste material is reacted with urea a partially hydrolyzed urea condensate is produced. When a dry organic waste material is reacted with urea a urea condensate-organic waste material is produced. The urea condensate-organic waste materials may be reacted with a phosphorus oxyacid and a potassium phosphate added to produce a urea condensate-organic waste composition. The urea condensate-organic waste products may be utilized as fertilizer or animal feed.

This application is a continuation-in-part of Ser. No. 08/723,779 filed Aug. 30, 1996, now U.S. Pat. No. 5,854,309, is a continuation-in-part of Ser. No. 09/693,194, filed Oct. 23, 2000 now U.S. Pat. No. 6,464,903 B1 and is a continuation-in-part of Ser. No. 09/973,553 filed Oct. 9, 2001.

### FIELD

This invention concerns urea and urea condensate reacted with organic waste materials for use as a slow release fertilizer which contains a portion which is water soluble and faster released by also contains a large portion which is not water soluble but is slowly released and available to the plants and may be utilized as cattle feed. The invention also concerns the preparation and use of nitrogen containing compound produced by reacting urea or urea condensates with itself and the compounds in organic waste materials such as sewer sludge. The nitrogen containing compounds produced by reacting urea, partially hydrolyzed urea condensates or urea condensate with sewer sludge or other organic waste materials and/or its composition is useful in the reduction of odor in the process of dehydrating sewer sludge, as a fertilizer. This urea condensate-organic sewer waste material composition contains a large portion of cellulosic fibers for moisture holding and building purposes of the soil and may be used to feed cattle.

### BACKGROUND

The use of aqueous or slow released granular nitrogen containing compound of partially hydrolyzed urea condensates or urea condensate reacted with organic waste materials such as sewer sludge as odor suppressant and as fertilizer and cattle feed are novel. When the powdered or granular or aqueous nitrogen containing compound urea, partially hydrolyzed urea condensate and urea condensate reacted with sewer sludge or other organic waste materials a longer lasting fertilizer is produced. Aqueous or solid partially hydrolyzed urea or urea condensate reaction products of sewer sludge and other organic waste used as a fertilizer and is very environmentally safe product to use on farms, vegetable gardens, golf courses and on residential landscape. The urea reacted with organic waste material increases the nitrogen content in the organic waste fertilizer and produces a slow release fertilizer. The water present in the organic waste materials reacts with urea to partially hydrolyze the urea which changes some of the —NH₂ radicals to —COONH₄ salt radicals which are slower to release the ammonia. Other useful compound which aids in plant growth may be added to the partially hydrated urea condensate-organic waste materials fertilizer such as phosphorus compounds, potassium compounds, minerals, borates, sulfur compounds, metal compounds and other useful compounds to assist in the growth of plants.

The organic waste materials, such as garbage, sewerage, canneries, decomposed leaves and grass, factory and municipal waste material, have been used as plant fertilizers because they contain plant nutrients such as nitrogen, phosphorus, and trace elements such as iron and manganese. The nitrogen content, phosphorus content and potassium content in the organic waste materials is relatively low and may be enhanced by adding and reacting urea based compounds with the waste materials and adding phosphorus compounds, potassium and minerals thereby making a desirable fertilizer for use on farms, parks, golf courses and along freeways. The production on a more useful fertilizer and agricultural animals feed for cellulose digesting animals would enable the cities to sell the enhanced organic waste fertilizer and animal feed, especially for feeding cattle in feed lots, thereby reducing the cost to the cities. The disposal of organic waste materials is a major problem for cities and is an expensive. The cities may utilize land fills to dispose of the organic waste materials or incinerate the waste materials. The land fills are getting full and it is necessary to find a more economic way to dispose of this water material or make it useful as a fertilizer or animal feed. These urea condensate-organic waste products may also be utilized as other agrochemical agent such as feeding cattle to fatten them up in stockyards. Urea and urea condensates such as biuret has used for years as feed for cattle in stockyards to increase the production of proteins in the meat. The urea products are mixed with the cattle feed.

### DESCRIPTION OF THE PRIOR ART

Fertilizer has been produced mixing and heating amino aldehyde reacted products with sewer sludge as in Moore's U.S. Pat. No. 4,519,831 wherein he utilizes sewer sludge mixed with an uncondensed urea-formaldehyde and phosphoric acid as the catalyst to condensate the urea-formaldehyde mixed in the sewer sludge. Karnemaat in his U.S. Pat. No. 3,713,800 also utilizes urea-formaldehyde prepolymer, formaldehyde which is mixed with composted organic waste material then phosphoric acid is added and acts as a catalyst to react the formaldehyde with the urea-formaldehyde prepolymer. This application is different from Moore's or Karnemast's patents because it does not utilize any aldehyde type compounds to produce amino-aldehyde products. The fertilizer and cattle feed produced by the process of this invention does not contain any aldehyde compounds. It is also not necessary to add a mineral acid such as phosphoric acid to produce the fertilizer by the process of this invention whereas in Karnematt's and Moore's process it is necessary to use a mineral acid. Wagner's U.S. Pat. No. 4,283,219 also utilizes an amino-aldehyde to react with an azulmic acid and a carbonyl compound such as unsaturated carboxylic acid, carboxylic acids, mineral acids or their salts to produce his fertilizer. Wagner's fertilizer is a reaction product an aldehyde and compounds containing NH₂ radical and an carbonyl compound to promote this reaction, whereas this invention does not utilize any aldehyde and does not produce an amino-aldehyde product but produces a partially hydrolyzed urea condensate-organic waste material fertilizer and urea condensate-organic waste material cattle feed.

What is lacking and what is needed are useful, safe and inexpensive products produced by reacting urea based compounds with organic waste materials such as sewer sludge. What is additionally lacking are compositions having aqueous or powdered nitrogen containing compound, such as urea, partially hydrolyzed urea or urea condensate reacted with organic waste materials, employed therein. What is also needed is a method to use organic waste material as useful products and reduce the cost of handling waste materials by the cities; What is additionally lacking is a method to reduce the odor from heating wet sewer sludge.

### SUMMARY

The wet sewer sludge cake, composed sludge and garbage contains many compounds both organic and inorganic but mostly cellulose materials. The urea and/or partially hydrolyzed urea condensate and/or urea condensate will react with many of the compounds that are found in the organic waste materials such as sulfur oxyacids, urea, amino compounds, carbohydrates, hemi-cellulose, cellulose, fatty acids, glycerine, amides, etc. Much of the sewer sludge and other organic waste materials contain non-reacted fillers which can act as a mulch around plants or as animal feed. By mixing and reacting urea based compounds the organic waste materials may be turned into a more useful and longer lasting fertilizer. The bacteria and virus are killed by heating the organic waste material to above 140 degree F.

In one aspect, the invention comprises the aqueous or powdered nitrogen containing compound, urea condensate-organic waste material compositions products produced by reacting urea or urea condensates with organic waste materials. Another aspect of the invention is a process to prepare the aqueous or solid nitrogen containing compounds produced by reacting urea and/or partially hydrolyzed urea condensate and/or urea condensates with water, itself and organic waste materials and/or a composition.

Another aspect of this invention is the process to prepare an aqueous or solid nitrogen containing compounds, urea condensate-organic waste material compositions and/or partially hydrolyzed urea condensate-organic waste material compositions produced by reacting urea and/or partially hydrolyzed urea condensate and/or urea condensate with organic waste such as sewer sludge, garbage and other organic waste materials and/or a composition by mixing:

(A) urea and/or partially hydrolyzed urea condensate and/or urea condensate, in the amount of 10 to 200 parts by weight;

(B) organic waste material, in the amount of 100 to 200 parts by dry weight, based on weight of component A;

(C) acidic salt forming compounds, in the amount of 0 to 300 parts by weight, based on the weight of component A;

(D) filler, in the amount of 0 to 300 parts by weight, based on the weight of component A;

(E) water, in the amount of 0 to 500 parts by weight, based on the weight of component A;

(F) metal compound, in the amount of 0 to 30 parts by weight based on the weight of component A.

Another aspect of this invention is the process to prepare an aqueous or solid nitrogen containing compounds, urea condensate-organic waste material composition produced by reacting urea or urea condensate with organic waste material such as dry sewer sludge, garbage and other organic waste materials and/or a composition by mixing, heating and reacting:

(A) urea and/or urea condensate, in the amount of 10 to 200 parts by weight;

(B) dry organic waste material, in the amount of 100 to 200 parts by dry weight, based on weight of component A;

(C) acidic salt forming compounds, in the amount of 0 to 300 parts by weight, based on the weight of component A;

(D) filler, in the amount of 0 to 300 parts by weight, based on the weight of component A;

(E) water, in the amount of 0 to 500 parts by weight, based on the weight of component A;

(F) metal compound, in the amount of 0 to 30 parts by weight, based on the weight of component A;

Another aspect of this invention is to utilized urea or urea condensate to react with the sulfur compounds in the sewer sludge to reduced the odor produced by heating the sewer sludge. The urea and urea condensate compounds also reacts with other compounds in the organic waste materials to produce fertilizer with an increase in the nitrogen content of the bio-fertilizer. The non-reacted urea based compounds may be used as a fertilizer or cattle feed.

### Component A

Urea in any suitable form such as granules, beads, powder or an aqueous solution, as a partially hydrolyzed urea condensate or as a urea condensate or mixture thereof may be used in this invention. Urea based compound is utilized in the amount of 10 to 200 parts by weight.

### Component B

Any suitable organic waste materials that will react with urea or urea based compounds such as sewer sludge, garbage, vegetable waste or composed organic waste materials may be used in this invention. It is preferred to be in the form of a damp or wet compressed solid mass then ground into smaller particles. The sewer outflow is treated with coagulating compounds and the solids are coagulated, then the excess water is filtered off. The remaining solids are compressed into a wet solid mass known as a cake. The compressed sewer sludge contains many different compounds such as cellulose, carbohydrates, nitrogen containing compounds such as urea, proteins, minerals, organic and inorganic salts, sulfur compounds and other compounds. Other organic waste material such as garbage, vegetable waste or composed organic waste material are ground up into small particles and may be moistened in order for the urea based compounds to be evenly mixed with the organic waste materials in orders to produce the partially hydrolyzed urea condensate-organic waster materials. Dry organic waste materials are utilized to produce the urea condensate-organic waste material composition. The organic waste material is utilized in the in the amount of 100 to 200 parts by weight.

### Component C

Any suitable acidic salt forming compounds or their salts may be utilized in this invention. Suitable salt forming compounds are compounds such as phosphorus acids, boric acids, nitric acid or sulfuric acids or their acidic salts. These acidic components are compounds such, for example, acids or salts, or their derivatives of sulfur, boron and phosphorus, such as, boron-phosphates, silicon-phosphorus compounds, phosphates, and polyphosphates of ammonia, amines, polyamines, amino compounds, thioureas and alkyanolamines, but boric acid and its salts and their derivatives, organic phosphorus compounds and their salts, halogenated organic phosphorus compounds, their salts and their derivatives, sulfuric acids, their salts and their derivatives such as ammonium sulfate, urea sulfate, etc., may also be used for this purpose. Phosphorus oxyacids or it's salts are the preferred acidic salt forming compound. The acidic salt forming compounds or their salts are not necessary but may be used in quantities of 0 to 300 parts by weight but when they are used they are used in the amount of 1 to 300 parts by weight.

The nitrogen containing salts of phosphorus oxyacids are the preferred acid forming compounds or their salts, such as amino phosphate, amine and polyamine phosphates, amino salts of organic phosphorus compounds, ammonium salts of inorganic or organic phosphorus oxyacids and amino condensation salt of inorganic and organic phosphorus compounds. The condensation salt of phosphorus compounds are produced by contacting urea condensates such as, biuret, cyanuric acid and cyamelide or other amino compounds with a phosphorus containing compound that will react with an amino compound, under conditions sufficient to prepare an amino salts of a phosphorus containing compound. Suitable inorganic phosphorus compounds include, but not limited to, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, and their salts, amino phosphates, amine phosphates, mono-metal hydrogen phosphates, ammonium dihydrogen phosphate, ammonium phosphate, bromated phosphates, alkali metal dihydrogen phosphate, and halogenated phosphate-phosphite and their halides and acids. organic phosphorus compounds include, but not limited to, alkyl, cyclic, aryl and alkyl-aryl phosphorus compounds, such as, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, ammonium phosphite, ammonium hydrogen phosphite-phosphates, urea hydrogen phosphite-phosphate, aryl hydrogen phosphates, halogenated phosphonates esters, biuret phosphate, cyanuric phosphate, cyamelide phosphate, and urea, biuret, cyanuric acid and cyamelide borates and mixtures thereof.

### Component D

Any suitable filler may be used in this invention. The fillers that may be utilized in the fertilizer and/or may be insoluble in the reaction mixtures. They may be inorganic substances, such as, ammonium salts of mineral acids, alkali metal compounds, alkaline earth metal compounds, alkali metal silicates, alkaline earth metal silicates, oxides or hydroxides, metal silicates, silica, metals oxides, metal carbonates, metal sulfates, metal phosphates, metal borates, glass beads or hollow glass beads. Potassium salts of inorganic or organic phosphorus compounds is preferred. They may be organic substances, such as, amino compounds, such as urea, melamine, dicyandiamide, urea condensates, urea-amino condensates, partially hydrolyzed urea condensates and other amino derivatives, amino phosphates, amino salts of organic phosphates, ammonium salts of organic phosphorus compounds, ammonium sulfates, urea sulfates, biuret sulfate, nitrogen containing sulfates, powdered coke, graphite, graphite compounds, lignin, lignin sulfate, lignin sulfite, diatomaceous earth and other absorbent materials and mixtures thereof. The filler may be used in the amount of 0 to 300 parts by weight. Fillers are not a necessary component, but useful, and if used they are used in the amount of 5 to 300 parts by weight.

### Component E

Any suitable metal-containing compound may be used in this invention. These compounds include, but not limited to, iron oxide, iron sulfates, alkaline earth metal borates such as magnesium borate, calcium magnesium borate and the like, manganese borate, zinc borate, metal oxides of titanium oxide, tin oxide, nickel oxide, zinc oxide, metal hydroxides such as aluminum hydroxide, iron hydroxide, magnesium hydroxide, calcium magnesium hydroxide, zirconium hydroxide and the like and mixtures thereof. The metal containing compounds are not necessary but may be utilized in the amount of 0 to 30 parts by weight. These metal containing when used, is used in the amount of 1 to 30 parts by weight.

### Component F

Water may be added to the reactants or may be added to the nitrogen containing compound, urea condensate-organic waste material or its composition to produce aqueous solutions. Water may be added in any suitable amount but usually in the amount of 1 to 500 parts by weight.

### Illustrative Embodiments

In general, the urea and/or aqueous urea are usually produced by reacting ammonia and carbon dioxide in an aqueous medium while under heat and pressure. This aqueous urea may be utilized in this invention or the urea can be crystalized by removing some of the water. The solid urea may then be added to water to form an aqueous solution of urea which usually contains less than 50% urea. The urea containing a limited amount of water may be heated to about its boiling point to produce partially hydrolyzed urea condensates or the urea is heated to or above the melting point to produce a urea condensate such as biuret, cyanuric acid and cyamelide. Ammonia is produced by heating urea to produce the urea condensate. The organic waste material has a low nitrogen content, such as an NPK analysis of about 1-2-0. It would be better if the fertilizer had a nitrogen content of 15-20 and phosphorus and potassium could be added to produce a better fertilizer.

The aqueous or solid nitrogen containing compounds, urea and urea condensate reacted with organic waste materials and/or it's composition is usually added on or incorporated in the sewer sludge or other waste materials at ambient temperature and pressure but elevated temperatures are utilized to react the urea based compounds with itself and sewer sludge and pressure may be utilized when necessary. In order to kill the bacteria and viruses it is necessary to heat the waste materials to above 140° F. It is preferable to utilize a method wherein the urea based compounds and additives are premixed with the ground organic waste material and carried out on a continuous basis using a heated blender and conveyor for blending and heating the fertilizer premix for 10 to 60 minutes at 100 to 160 degree C. The fertilizer is then ground up by any suitable method and screened to any desired particle size. The fertilizer may be added to water to devolve out the water soluble fertilizer then filtered from the unsoluble portion of the fertilizer. The aqueous fertilizer is sprayed on the crops using a water spraying system or plowing it into the soil. The granular urea condensate or hydrolyzed urea condensate-organic waste material fertilizer may be spread out over the growing plants or mixed with cattle feed and feed the amimals.

The nitrogen containing compound urea condensate salt of sulfur oxyacid may be produced by heating urea with the sulfur containing compounds in the sewer sludge and thereby reducing the amount of sulfur oxides which is released into the air. When urea is heated it reacts with itself to produce condensates such as biuret, cyanuric acid and cyamelide. Ammonia is produced in the condensate reaction. The ammonium urea condensate salt of sulfur oxyacid may also be produced by reacting aqueous ammonium, urea and sulfur oxyacid found in the sewer sludge. These chemical reactions may take place at ambient or elevated temperature sufficient to melt the urea ranging from ambient to 180° C. When the ground organic waste contains water and heated with urea some of the urea is partially hydrolyzed and reacts with urea to from a partially hydrolyzed urea condensate.

### DESCRIPTION OF PREFERRED EXAMPLES

The present invention will now be explained herein-after by way of a few examples and comparative examples, these examples setting, however, no limits to this invention. Parts and percentage are by weight, unless otherwise indicated.

### Example 1

The solids in sewer material is coagulated by the use of a coagulating chemical then filter and compressed to remover the excess water to form a wet filter cake. 20 parts by weight of urea is mixed with 100 parts by weight of the wet filter cake then heated to 110° o 130° C. for 20-30 minute or until the mixture was dry. The water in the wet filter cake reacts with the urea and on further heating the hydrolyzed urea react with urea and the sewer waste to form a partially hydrolyzed urea condensate-organic waste material. The odor produced when heating the sewer sludge cake is reduced by the reaction of urea reacting with the sulfur containing compounds. The partially hydrolyzed urea condensate-organic waste composition is then ground into granules or powder and used as a fertilizer or mixed with animal food and fed to animals. The powder may be dissolved in water to for an aqueous solution or emulsion. The undissolved portion is filtered off and used as mulching material and fertilizer.

### Example 2

Example 1 is modified wherein about equal parts by weight, based on weight of dry sewer sludge, is mixed with equal parts by weight of urea thereby producing a fertilizer, a partially hydrolyzed urea condensate-organic waste composition which contains about 20% nitrogen.

### Example 3

Example 1 is modified wherein the sewer cake is first dried, ground to small particles, then the urea is added and mixed thorough, then heated to 110-140 degrees C. for 20 to 30 minutes thereby producing a urea condensate-organic waste material fertilizer or cattle feed which is ground to the desired particle size.

### Example 4

Example 1 is modified wherein 15 parts by weight of phosphoric acid is added to the partially hydrolyzed urea condensate-organic waste material and heating is continued at 120 degree C. until the partially hydrolyzed urea condensate-organic waste salt phosphoric acid composition fertilizer is dry, then it is ground into small particles

### Example 5

Example 1 is modified wherein a filler in the amount of 5 parts by weight is added to the partially hydrolyzed urea condensate-organic waste composition and selected from the group consisting of alkali metal compounds, alkaline earth metal compounds, alkali metal silicates, alkaline earth metal silicates, oxides or hydroxides, metal silicates, silica, metals oxides, metal carbonates, metal sulfates, metal phosphates, metal borates, glass beads or hollow glass beads, potassium salts of inorganic or organic phosphorus compounds, amino compounds, such as urea, melamine, dicyandiamide, urea condensates, urea-amino condensates, partially hydrolyzed urea condensates and other amino derivatives, amino phosphates, amino salts of organic phosphates, ammonium salts of organic phosphorus compounds, ammonium salts of phosphoric-phosphorous acid, ammonium sulfates, urea sulfates, biuret sulfate, nitrogen containing sulfates, powdered coke, graphite, graphite compounds, lignin, lignin sulfate, lignin sulfite, diatomaceous earth and other absorbent materials and mixtures thereof.

### Example 6

Example 3 is modified wherein 10 parts by weight of an acidic salt forming compound is added and mixed with the urea condensate-organic waste material, then heated to 120 degree C. until the composition is dry. The fertilizer composition is ground into small particles. The acidic salt forming compound is selected from the following group consisting of phosphorus acids, phosphoric acid, boric acids, nitric acid or sulfuric acids or their acidic salts, phosphates and polyphosphates of ammonia, amines, polyamines, amino compounds, thioureas and alkyanolamines, boric acid and its salts and their derivatives, organic phosphorus compounds and their salts, halogenated organic phosphorus compounds, their salts and their derivatives, sulfuric acids, their salts and their derivatives such as ammonium sulfate, urea sulfate, amino phosphate, amine and polyamine phosphates, amino salts of organic phosphorus compounds, ammonium salts of inorganic or organic phosphorus oxyacids and amino condensation salt of inorganic and organic phosphorus compounds, biuret, cyanuric acid and cyamelide salts of phosphorus compounds, phosphorus containing compound, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, amino phosphates, amine phosphates, mono-metal hydrogen phosphates, ammonium dihydrogen phosphate, ammonium phosphate, alkali metal dihydrogen phosphate, halogenated phosphate-phosphite and their halides and acids, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, ammonium phosphite, ammonium hydrogen phosphite-phosphates, aryl hydrogen phosphates, halogenated phosphonates esters, biuret phosphate, cyanuric phosphate, cyamelide phosphate and mixtures thereof.

### Example 7

Example 1 is modified wherein a acidic potassium salt of organic or inorganic phosphorus oxyacid compounds in the amount of 10 parts by weight is added and mixed with the partially hydrolyzed urea condensate-organic waste material then heated to 100 degree C. for 20 minutes thereby producing a partially hydrolyzed urea condensate-organic wasted material composition.

### Example 8

Example 1 is modified wherein an acidic salt forming compound in the amount of 10% by weight, based on the weight of the urea is added to the organic waste material and is selected from the list below:

a) pyrophosphoric acid
b) phosphinic acid
c) phosphorus trichloride
d) phosphorus oxytrichloride
e) phosphorus oxide
f) ammonium dihydrogen phosphate
g) mono-aluminum phosphate
h) dimethyl methyl phosphonate (DMMP)
i) dimethyl hydrogen phosphite
m) phosphorus thiochloride
j) phenyl acid phosphate
k) methylchlorophosphine
l) phosphorus
n) tris(2-chloropropyl) phosphate
o) triphenyl phosphite
p) tris 2-chloroethyl phosphite
q) triethyl phosphite
r) urea dihydrogen phosphate
s) diethyl phosphite
t) trimethyl phosphite
u) dibutyl pyrophosphoric acid
v) O,O-dimethyl hydrogen dithiophosphate
w) melamine hydrogen boron-phosphate
x) hypophosphorous acid
y) methyl amine salt of phosphoric acid
z) ammonium sulfate

### Example 9

10 parts by weight of urea is added to and mixed with 30 parts by weight of sewer sludge cake with the excess water pressed out. The mixture is heated to about 140 degree C. for about 30 minutes thereby producing a partially hydrolyzed urea condensate-organic waste composition fertilizer. The urea reacted with the sulfur containing compounds and reduced the odor produced by heating the sewer sludge. The mixture is then ground into powder or granules.

### Example 10

Example 9 is modified wherein a metal compound in the amount of 1 Part by weight is added and mixed with the partially hydrolyzed urea condensate-organic waste then ground into small particles. The metal compound is selected from the group consisting of compounds magnesium borate, calcium magnesium borate, manganese borate, zinc borate, metal oxides of titanium, potassium hydroxide, iron sulfate, calcium hydroxide oxide, tin oxide, nickel oxide, zinc oxide, iron oxides, aluminum hydroxide, magnesium hydroxide, calcium magnesium hydroxide, zirconium hydroxide, lime and mixtures thereof.

### Example 11

Composed garbage in the amount of 100 parts by weight is heated to about 120 degrees C. until the moisture content is about 3-5% then it is subdivided by a hammer mill until most of the material will pass through a 30 mesh screen. 30 parts by weight of urea is mixed with the dried composed garbage particles then heated to about 140 degrees C. for about 30 minutes thereby producing a urea condensate-organic waste material fertilizer or cattle feed. To this fertilizer an acidic salt forming compound in the amount of 10 parts by weight is added and mixed in the urea condensate-organic waste material and heated to 120 degree C. for about 10 minutes. The fertilizer is then cooled and subdivided into small particles. The acidic salt forming compound is selected from the list below:

```
a) melamine hydrogen phosphate
b) cyandiamide hydrogenphosphate
c) urea dihydrogen phosphate
d) guanidine phosphate
e) aminoguanidine phosphate
f) ethyltriamine urea hydrogen phosphate
g) melamine salt of dimethyl methyl phosphonate
h) melamine salt of dimethyl hydrogen phosphite
i) methylamine melamine phosphoric acid
j) methyl carbamate salt of phosphoric acid
k) melamine salt of boron-hydrogen phosphate
l) potassium hydrogen phosphate
m) urea salt of boron-phosphate
n) urea-formaldehyde phosphate
o) aminophenol phosphate
p) ammonium urea phosphate
q) ammonium melamine phosphate
r) melamine salt of trimethyl
    phosphite
s) melamine salt of phenyl acid
    phosphate
t) cyanuric hydrogen phosphate
```

### Example 12

Example 11 is modified wherein 2 parts by weight of a metal compound is added and mixed with the fertilizer particles of Example 11 and selected from the group consisting of iron oxide, iron sulfate, calcium borate, ammonium borate, lime, aluminum silicate and mixtures thereof.

### Example 13

Example 1 is modified wherein the urea containing 10% water is heat to about 110 degrees C. thereby producing an aqueous urea condensate, then reacted with the sewer sludge.

### Example 14

Example 9 is modified wherein 20 parts by weight of an acidic salt forming compound is added to 100 parts by weight of the partially hydrolyzed urea condensate-sewer sludge composition and the acidic salt forming compound is selected from the list below:

```
a) melamine phosphate
b) cyandiamide phosphate
c) urea dihydrogen phosphate
d) guanidine phosphate
e) aminoguanidine phosphate
f) diethyltriamine urea phosphate
g) melamine salt of dimethyl methyl phosphonate
h) melamine salt of dimethyl hydrogen phosphite
i) methylamine melamine phosphoric acid
j) methyl carbamate salt of phosphoric acid
k) melamine salt of boron-hydrogen phosphate
l) O-methyl urea sulfate
m) urea salt of boron-phosphate
n) urea hydrogen phosphate
o) aminophenol phosphate
p) ammonium urea phosphate
q) ammonium melamine phosphate
r) melamine salt of trimethyl
    phosphite
s) melamine salt of phenyl acid
    phosphate
t) ammonium sulfate
```

### Example 15

Example 9 is modified wherein 10 parts by weight of a filler selected from the list below is added to the powdered urea condensate-organic waste composition:

a) hydrated aluminum oxide powder
b) hydrated sodium silicate powder
c) melamine
d) dicyandiamide
e) urea sulfate
f) melamine phosphate
g) melamine borate
h) ammonium phosphate
i) ammonium pyrophosphate
j) ammonium carbonate
k) ammonium borate
l) ammonium sulfamate
m) guanidine
n) guanidine carbonate
o) urea phosphate
p) silica powder
q) phenol-formaldehyde resin powder
r) aluminum phosphate
s) thiourea
t) hollow beads
u) potassium salt of phosphorous acid
v) melamine salt of DMMP
r) ammonium sulfate
s) magnesium chloride
t) antimony trioxide
u) boron-phosphate powder
v) melamine boron-phosphate powder
w) lignin
x) lignin sulfate

### Example 16

Example 9 is modified wherein 10 parts by weight of a phosphorus salt forming compound is added to the partially hydrolyzed urea condensate-organic waste composition and selected from the list below:

a) phosphoric acid
b) pyrophosphoric acid
c) dimethyl methyl phosphonate (DMMP)
d) dimethyl hydrogen phosphite
e) trimethyl phosphite
f) phenyl acid phosphate
g) phosphorus trichloride
h) phosphinic acid
i) phosphorus oxytrichloride
j) ammonium dihydrogen phosphate
k) dimethyl phosphoric acid
l) diethyl ethyl phosphonate
m) magnesium hydrogen phosphate
n) mono aluminum phosphate

### Example 17

Example 16 is modified wherein 5 parts by weight of potassium hydroxide is added and reacted with the urea condensate-organic waste composition.

### Example 18

50 parts by weight of organic waste form a fruit cannery is pressed to remove excess water then ground into particles that will pass through a No. 4 screen then 20 parts by weight of urea is added, mixed then heated to about 150 degrees C. or 40 minutes to produce a partially hydrolyzed urea condensate-organic waste material fertilizer or cattle feed which is then ground into particles that will pass thru a No. 30 screen.

### Example 19

Example 18 is modified wherein the organic waste material is grounded, dried to where it contains about 34% water, then reacted with the urea thereby producing a urea condensate-organic waste material which is ground into particles that will pass thru a No. 50 screen. This material is then mixed with 500 parts by weight of grain and feed to cattle.

### Example 20

Example 19 is modified where another organic waste material is used in place of fruit cannery waste and selected from the list below:

a) sewer sludge
b) garbage waste
c) garbage compose
d) apple cannery waste
e) tomato cannery waste
f) composed grass
g) vegetable cannery waste
h) composed corn stalks
i) mixtures of the above

### Example 21

Example 18 is modified wherein the partially hydrolyzed urea condensate-organic waste material is mixed with 10 parts by weight of potassium hydrogen phosphite then heated to 120 degree C. for 20 minutes thereby producing a partially hydrolyzed urea condensate-organic waste composition fertilizer.

### Example 22

Example 21 is modified wherein another salt forming compound is added in place of potassium hydrogen phosphite and selected from the list below:

```
a) melamine hydrogen phosphate
b) dicyandiamide phosphate
c) urea dihydrogen phosphate
d) guanidine hydrogen phosphate
e) aminoguanidine hydrogenphosphate
f) diethyltriamine urea phosphate
g) melamine salt of dimethyl methyl phosphonate
h) melamine salt of dimethyl hydrogen phosphite
i) methylamine melamine phosphoric acid
j) methyl carbamate salt of phosphoric acid
k) melamine salt of boron-hydrogen phosphate
l) O-methyl urea phosphite
m) urea salt of boron-phosphate
n) urea hydrogen phosphate
o) aminophenol phosphate
p) ammonium urea phosphate
q) ammonium melamine phosphate
r) melamine salt of trimethyl
    phosphite
s) melamine salt of phenyl acid
    phosphate
t) ammonium sulfate
u) lignin phosphate
```

### Example 23

Fifty parts by weight of urea is mixed with 200 parts by weight of composted garbage from a fruit cannery which contains about 15% water and has been ground into small particles which will pass through a 4 mesh screen then heated to about 150 degrees C. for 30 minutes thereby producing a partially hydrolyzed urea condensate-organic waste material fertilizer or cattle feed. The fertilizer or cattle feed is ground into small particles which will pass through a 2 mesh screen.

### Example 24

Example 23 is modified wherein a salt forming compound in the amount of 15 parts by weight is added and mixed with the partially hydrolyzed urea-organic waste material fertilizer and selected from the list below:

```
a) melamine phosphate
b) dicyandiamide phosphate
c) urea dihydrogen phosphate
d) guanidine phosphate
e) aminoguanidine phosphate
f) diethyltriamine urea phosphate
g) urea salt of dimethyl methyl phosphonate
h) melamine salt of dimethyl hydrogen phosphite
i) melamine salt of phosphoric acid
j) methyl carbamate salt of phosphoric acid
k) melamine salt of boron-hydrogen phosphate
l) Melamine DMMP
m) urea salt of boron-phosphate
n) urea hydrogen phosphate
o) aminophenol phosphate
p) ammonium urea phosphate
q) ammonium melamine phosphate
r) melamine salt of trimethyl
    phosphite
s) melamine salt of phenyl acid
    phosphate
t) ammonium sulfate
u) urea condensate phosphate
```

### Example 25

One half of the flower on the south east side of a house was fertilized with the fertilizer produced in Example 1 and the other half of the same type of flower on the south west side of the house were fertilized with the same weight of urea. The plants were watered every 3 days. The plants grew about the same for 10 days then the plants fertilized with the fertilizer produced in Example 1 began to grow larger than the plants fertilized with urea. The flower on the south east side produced about twice as many flowers especially the Easter lilies and continue to grow more for about 6 months without any more fertilizer.

### Example 26

A dozen similar tomato plants of about 4-5 inches tall were planted in a garden then around the plants 100 grams of the partially hydrolyzed urea condensate-organic waste material of Example 23 was placed around one half of the plants. The plants were watered every other day using the same amount of water. In 10 days the fertilized plants grew 34 inches taller than the unfertilized plant and were much fuller. The fertilized plant continue to grow faster, became taller and wider, and produced more tomatoes than the unfertilized plants.

### Example 27

About 100 parts by weight of the of the fertilizer produced in example 1 was placed in about equal parts by weight of water for 2 hours then the mixture was filtered to remove the water soluble fertilizer. The aqueous fertilizer was placed in a dispensing bottle which is attached to a watering hose. The fertilizer is diluted with the water and was sprayed on 200 square feet of dying grass lawn. The lawn was watered every other day and with in 3 days the grass begin to turn green and by one week had grown several inches. Another 200 square feet of the same lawn was sprayed the same way with an aqueous solution of aqueous urea and the lawn was watered every other day and this section of lawn also turned green and started to grown but after 2 weeks this section of lawn stopped growing whereas the section of lawn that was fertilized with the partially hydrolyzed urea-organic waste material composition continue to grow for about 2 months. The unsoluble portion of the fertilizer was placed in a pot that contains a tomato plant that appeared to be dying. The plant was water every other day and after 4 days the plant begin to grow and turned green. The fertilizer continued to be slowly released and the plant continued to grow for 3 months and produced a good crop of tomatoes.

### Example 28

Example 27 is modified wherein 10 parts by weight of a filler is added to the partially hydrolyzed urea condensate-organic waste material and selected from the list below:

a) diaminophosphate
b) dimethyl methyl phosphonate
c) urea phosphate
d) melamine borate
e) ammonium melamine boron phosphate
f) diethyl phosphite
g) ammonium polyphosphate
h) dicyandimide phosphate
i) ammonium phosphate
j) aluminum phosphate
k) tris2-chloroethyl phosphite
l) zinc borate
m) boron oxide
n) boric acid
o) dimethyl phosphite
p) triethy phosphate
q) guanidine phosphate
r) ammonium sulfamate

### CONCLUSION

The partially hydrolyzed urea condensate-organic waste material composition and the urea condensate-organic waste material composition produced by the process of this invention contain both a water soluble portion and a non-water soluble portion. The water soluble portion contains a nitrogen compound which releases nitrogen fast and a slower release portion and the non-water soluble portion release the nitrogen slowly. The water in the organic waste material react with the urea which produces and ammonium salt containing compounds which reacts with other urea compounds to produce a partially hydrolyzed urea condensate.

It will be appreciated by those skilled in the Arts that changes and modifications of the preferred embodiment can be made without departing from the spirit and broader aspects of the invention as set forth in the appended claims.

I claim:

1. A partially hydrolyzed urea condensate-organic waste material composition fertilizer and animal feed produced by the process of mixing, heating and reacting the following components:
A) urea and/or urea condensate, in the amount of 25 to 200 parts by weight;
B) organic waste material containing 5-15% water and subdivided into small particles, in the amount of 100 to 200 parts by weight;
C) acidic salt forming compound, in the amount of 0 to 300 parts by weight;
D) filler, in the amount of 0 to 300 parts by weight;
E) metal compound, in the amount of 0 to 30 parts by weight;
F) water, in the amount of 0 to 500 parts by weight;
component A and B are mixed then heated at 110 to 180 degrees C., to react the water with urea and to react the urea with itself and with the organic waste material, and remove water and volatilized organic materials, dried, then component C is added, mixed and/or reacted, then components D, E and F are added and mixed, then the dried partially hydrolyzed urea condensate-organic waste material composition is subdivided to the desirable particle size.

2. The partially hydrolyzed urea condensate-organic waste material composition fertilizer and animal feed of claim 1 wherein the acidic salt forming compound is selected from the group consisting of phosphorus containing compounds, boron containing compounds, boron-phosphate containing compounds, silicon-phosphorus containing compounds and sulfur containing compounds, in an amount of 0 to 300 parts by weight.

3. The partially hydrolyzed urea condensate-organic waste material composition fertilizer and animal food of claim 1 wherein the filler is selected from the group consisting of alkali metal compounds, alkaline earth metal compounds, alkali metal silicates, alkaline earth metal silicates, oxides or hydroxides, metal silicates, silica, metals oxides, metal carbonates, metal sulfates, metal phosphates, metal borates, glass beads or hollow glass beads amino compounds, such as urea, melamine, dicyandiamide, urea condensates, urea-amino condensates, partially hydrolyzed urea condensates, amino phosphates, amino salts of organic phosphates, ammonium salts of phosphate, ammonium salts of organic phosphorus compounds, ammonium sulfates, urea sulfates, biuret sulfate, nitrogen containing sulfates, powdered coke, graphite, graphite compounds, lignin, lignin sulfate, l lignin sulfite, potassuim phosphate, potassium salt of phosphorous acid, diatomaceous earth, other absorbent materials and mixtures thereof.

4. The partially hydrolyzed urea condensate-organic waste material composition of claim 1 where in the organic waste material is dried until it contains less than 3% water thereby producing a urea condensate-organic waste material composition fertilizer and animal feed.

5. The partially hydrolyzed urea condensate-organic waste material composition fertilizer of claim 1 wherein the acidic salt forming compound is potassium hydrogen phosphate.

6. The partially hydrolyzed urea condensate-organic waste material composition of claim 1 wherein the salt forming compound is potassium hydrogen phosphorous acid.

7. The process for the production of partially hydrolyzed urea condensate-organic waste material compositions fertilizer and animal feed, comprising of mixing, heating and reacting the following components:
A) urea and/or urea condensate, in the amount of 25 to 200 parts by weight;
B) organic waste material containing 5-15% water and subdivided into small particles, in the amount of 100 to 200 parts by weight;
C) acidic salt forming compound, in the amount of 0 to 300 parts by weight;
D) filler, in the amount of 0 to 300 parts by weight;
E) metal compound, in the amount of 0 to 30 parts by weight;
F) water, in the amount of 0 to 500 parts by weight;
component A and B are mixed then heated at 110 to 180 degrees C., to react the water with urea and to react the urea with itself and with the organic waste material and remove water and volatilized organic materials, dried, then component C is added, mixed and/or reacted then components D, E and F are added and mixed then the partially hydrolyzed urea condensate-organic waste material composition is subdivided to the desirable particle size.

8. A urea condensate-organic waste material composition fertilizer and farm animal feed produced by the process of mixing, heating and reacting the following components:
A) urea and/or urea condensate, in the amount of 25 to 200 parts by weight;
B) organic waste material containing less than 5% water and subdivided into small particles, in the amount of 100 to 200 parts by weight;
component A and B are mixed then heated at 110 to 180 degrees C., to react the urea with itself and with the organic waste material and remove volatilized organic materials, dried, then the urea condensate-organic waste material composition is subdivided to the desirable particle size.

9. The flame retardant composition of claim 7 wherein the filler is selected from the group consisting of urea, melamine, dicyandiamide, melamine cyanurate, amino phosphates, amino polyphosphates, aminoplasts, phenoplasts, powdered synthetic resins, sawdust, lignin, lignin sulfate, lignin sulfite, carbohydrates, bituminous additives, graphite, graphite compounds, powdered coke, silica, alkali metal silicates, alkaline earth metal silicates, metals, metal silicates, metal oxides, metal carbonates, metal sulphates, metal phosphates and metal borates, glass beads, hollow glass beads, hydrated aluminum oxide, biuret, cyanuric acid, cyamelide and mixtures thereof, in an amount 0 to 300 parts by weight.

9. The partially hydrolyzed urea condensate-organic waste material composition fertilizer of claim 1 wherein the filler is selected from the group consisting of alkali metal compounds, alkaline earth metal compounds, alkali metal silicates, alkaline earth metal silicates, silicon oxides, metal silicates, silica, metals oxides, metal carbonates, metal sulfates, metal phosphates, metal borates, glass beads or hollow glass beads amino compounds, such as urea, melamine, dicyandiamide, urea condensates, urea-amino condensates, partially hydrolyzed urea condensates, amino phosphates, amino salts of organic phosphates, ammonium salts of phosphate, ammonium salts of organic phosphorus compounds, ammonium sulfates, urea sulfates, biuret sulfate, nitrogen containing sulfates, powdered coke, graphite, graphite compounds, lignin, lignin sulfate, lignin sulfite, potassuim phosphate, potassium salt of phosphorous acid, diatomaceous earth, other absorbent materials and mixtures thereof.

10. A partially hydrolyzed urea condensate-organic waste material composition fertilizer and animal food produced by the process consisting of mixing, heating and reacting the following components:
A) urea and/or urea condensate, in the amount of 25 to 200 parts by weight;
B) organic waste material containing 5-15% water and subdivided into small particles, in the amount of 100 to 200 parts by weight;
component A and B are mixed then heated at 110 to 180 degrees C., to react the water with urea and to react the urea with itself and with the organic waste material and remove water and volatilized organic materials, dried, then the dried partially hydrolyzed urea condensate-organic waste material composition is subdivided to the desirable particle size.

10. The partially hydrolyzed urea condensate-organic waste material composition fertilizer and animal feed of claim 7 wherein the salt forming compound is an ammonium phosphate/phosphite acidic compound.

11. The partially hydrolyzed urea condensate-organic waste material composition fertilizer and animal feed of claim 7 wherein the salt forming compound is an ammonium hydrogen phosphite.

12. The partially hydrolyzed urea condensate-organic waste material composition fertilizer and animal feed of claim 7 wherein the salt forming compound is an ammonium polyphosphate.

13. The product produced by the method of claims 7, 9, 10, 11 and 12.

14. The partially hydrolyzed urea condensate-organic waste material composition fertilizer and animal feed of claim 1 wherein the salt forming compound is an ammonium hydrogen phosphate/phosphite.

15. The partially hydrolyzed urea condensate-organic waste material composition fertilizer and animal feed of claim 1 wherein the salt forming compound is a potassium hydrogen phosphite.

16. The partially hydrolyzed urea condensate-organic waste material composition fertilizer and animal feed of claim 1 wherein the filler is ammonium sulfate.

17. The partially hydrolyzed urea condensate-organic waste material composition fertilizer and animal feed of claim 1 wherein the salt forming compound is phosphorous acid.

18. The partially hydrolyzed urea condensate-organic waste material composition fertilizer and animal feed of claim 1 wherein the filler is potassium ammonium salt of phosphorous acid

19. The partially hydrolyzed urea condensate-organic waste material composition fertilizer and animal feed of claim 1 wherein the filler is urea.

20. The partially hydrolyzed urea condensate-organic waste material composition fertilizer and animal feed of claim 1 wherein the metal compound is selected from the group consisting of iron oxide, iron sulfates, alkaline earth metal borates such as magnesium borate, calcium magnesium borate and the like, manganese borate, zinc borate, metal oxides of titanium oxide, tin oxide, nickel oxide, zinc oxide, metal hydroxides such as aluminum hydroxide, iron hydroxide, magnesium hydroxide, calcium magnesium hydroxide, zirconium hydroxide and the like and mixtures thereof.

21. The process for the production of partially hydrolyzed urea condensate-organic waste material composition fertilizer and animal food of claim 7 wherein the metal compound is selected from the group consisting of iron oxide, iron sulfates, alkaline earth metal borates such as magnesium borate, calcium magnesium borate and the like, manganese borate, zinc borate, metal oxides of titanium oxide, tin oxide, nickel oxide, zinc oxide, metal hydroxides such as aluminum hydroxide, iron hydroxide, magnesium hydroxide, calcium magnesium hydroxide, zirconium hydroxide and the like and mixtures thereof.

22. The partially hydrolyzed urea condensate-organic waste material fertilizer and animal feed of claim 4 where in the filler is selected from the group consisting of urea, biuret, cyanuric acid and mixtures thereof.
